(19) United States
(12) Patent Application Publication
(10) Pub. No.: US 2019/0063388 A1
(43) Pub. Date: Feb. 28, 2019

(54) Damper Capsule, Pressure Variation Damper, and High-Pressure Fuel Pump

(71) Applicant: Continental Automotive GmbH, Hannover (DE)

(72) Inventor: Yavuz Kurt, Roding (DE)

(73) Assignee: Continental Automotive GmbH, Hannover (DE)

(21) Appl. No.: 16/080,121

(22) PCT Filed: Feb. 7, 2017
(86) PCT No.: PCT/EP2017/052660

§ 371 Date: Aug. 27, 2018

(30) Foreign Application Priority Data
Feb. 29, 2016 (DE) 10 2016 203 217.8

(51) Int. Cl. F02M 55/04; F02M 37/00; F02M 59/48

(52) U.S. Cl. CPC F02M 55/04; F02M 37/0041; F02M 2200/8084; F02M 2200/315; F02M 2200/26; F02M 59/48

(57) ABSTRACT

Various embodiments may include a damper capsule comprising: a damping volume including a diaphragm having a deformation region deformable along a deformation axis by pressure pulsations and a connecting region; and a closure element for closing off the damping volume and connected to the diaphragm by a closure element. The diaphragm includes a profile region forming a spacer for separating the deformation region, in the direction of the deformation axis, from holding elements which hold the damper capsule when the damper capsule has been installed. The deformation region, the connecting region, and the profile region comprise a unipartite diaphragm component.

### CROSS-REFERENCE TO RELATED APPLICATIONS

This application is a U.S. National Stage Application of International Application No. PCT/EP2017/052660 filed Feb. 7, 2017, which designates the United States of America, and claims priority to DE Application No. 10 2016 203 217.8 filed Feb. 29, 2016, the contents of which are hereby incorporated by reference in their entirety.

### TECHNICAL FIELD

The present disclosure relates to pumps. Various embodiments may include a damper capsule for a pressure pulsation damper of a high-pressure fuel pump, a pressure pulsation damper that has a damper capsule, and/or a high-pressure fuel pump that has a pressure pulsation damper.

### BACKGROUND

High-pressure fuel pumps are used, in fuel injection systems by means of which fuel is injected into combustion chambers of an internal combustion engine, to apply a high pressure to the fuel. “High-pressure”, in this context, means the pressure ranges from 150 bar to 400 bar, for example in gasoline internal combustion engines, and/or in a range from 1500 to 2500 bar, for example in diesel internal combustion engines. The higher the pressure which can be generated in the respective fuel, the lower the emissions which arise during the combustion of the fuel in the combustion chamber, this being advantageous in particular against the background of a reduction in emissions being desired to an ever greater extent.

To achieve the high pressures in the respective fuel, the high-pressure fuel pump may comprise a piston pump performing a translational movement in a pressure chamber and in so doing periodically compressing and relieving the pressure on the fuel. The non-uniform delivery that is thus realized by means of such a piston pump leads to fluctuations in the volume flow in a low-pressure region of the high-pressure fuel pump, which fluctuations are associated with pressure fluctuations in the entire system. As a consequence of these fluctuations, filling losses can occur in the high-pressure fuel pump, as a result of which correct dosing of the fuel quantity required in the combustion chamber is difficult. The pressure pulsations that arise furthermore cause pump components, such as for example feed lines to the high-pressure fuel pump, to vibrate, which vibrations can cause undesired noises or, in the worst case, even damage to various parts.

A pressure pulsation damper is therefore normally provided in the low-pressure region of the high-pressure fuel pump, wherein the pressure pulsation damper operates as a hydraulic accumulator which evens out the fluctuations in the volume flow and thus reduces the pressure pulsations that arise. For this purpose, deformable elements are installed to separate a gas volume from the fuel. Such deformable elements may be formed for example as damper capsules, which have a damping volume defined by at least one diaphragm. If the pressure for example in the low-pressure region of the high-pressure fuel pump increases, the damper capsule deforms, wherein the gas volume enclosed therein is compressed and space is created for the superfluous liquid of the fuel. If the pressure falls again at a later point in time, the gas expands again, and the stored liquid of the fuel is thus released again.

The stated damper capsules usually have at least one diaphragm composed of metal, which at least jointly defines a damping volume, wherein the damping volume is filled with gas and closed. The damper capsules are normally installed within the pressure pulsation damper with the aid of so-called spacer sleeves, which firstly serve as distancing pieces and are secondly prestressed during the assembly process to thereby relieve connecting regions, for example weldments, of load.

The production of said spacer sleeves, which are normally produced as deep-drawn parts or punched parts, is relatively cumbersome and therefore expensive.

### SUMMARY

The teachings of the present disclosure may include an alternative possibility for the installation of a damper capsule in a pressure pulsation damper of a high-pressure fuel pump. For example, some embodiments may include a damper capsule (24) for a pressure pulsation damper (22) of a high-pressure fuel pump (10) in a fuel injection system, having a damping volume (28) which is formed by at least one diaphragm (30), wherein the diaphragm (30) has a deformation region (34) which is deformable along a deformation axis (36) by pressure pulsations and which serves for forming the damping volume (28) and which has a connecting region (40) for connecting the diaphragm (30) to a closure element (32) which closes off the damping volume (28), wherein the diaphragm (30) has a profile region (42) which forms a spacer (44) for spacing the deformation region (34) apart, in the direction of the deformation axis (36), from holding elements which hold the damper capsule (24) when the damper capsule (24) is in an installed state, and wherein the deformation region (34), the connecting region (40) and the profile region (42) are formed as a unipartite diaphragm component (46).

In some embodiments, the profile region (42) is formed as a spring element (50), and is formed so as to be resilient in particular in a direction parallel to the deformation axis (36).

In some embodiments, the profile region (42) has passage openings (52) through which fuel can flow during operation.

In some embodiments, the deformation region (34), the connecting region (40) and the profile region (42) are arranged and/or formed rotationally symmetrically about a central axis (54), running parallel to the deformation axis (36), of the damper capsule (24).

In some embodiments, the profile region (42) is formed as a profile ring (60) which is arranged rotationally symmetrically about the central axis (54) and which is formed in particular from profile ring parts (66) spaced apart by interruption openings (64).

In some embodiments, the profile region (42) is formed as a U-shaped profile (62) in cross section, wherein a first U limb (68) forms the connecting region (40) and a second U limb (70) forms a support region (74) for the support of the damper capsule (24) on the holding elements.

In some embodiments, the profile region (42) is formed as an S-shaped profile (76) in cross section, which has a contact loop (78) for imparting a prestress to a connecting seam (80) between the diaphragm (30) and the closure element (32) in the connecting region (40).

In some embodiments, the diaphragm (30) and the closure element (32) are connected to one another in gas-tight fashion, in particular by adhesive bonding or welding, to form the damping volume (28), wherein, in particular, a gas (38) is arranged in the damping volume (28).

In some embodiments, the closure element (32) is formed as a closure diaphragm (56) which has a deformation region (34) of mirror-symmetrical form with respect to the diaphragm (30) and a connecting region (40) of mirror-symmetrical form with respect to the diaphragm (30), wherein the closure diaphragm is in particular entirely of mirror-symmetrical form with respect to the diaphragm (30).

Some embodiments may include a pressure pulsation damper (22) for a high-pressure fuel pump (10) having a damper capsule (24) as described above. Some embodiments may include a high-pressure fuel pump (10) for applying high pressure to a fuel in a fuel injection system, having a pressure pulsation damper (22) as described.

### BRIEF DESCRIPTION OF THE DRAWINGS

Various embodiments of the teachings here are explained in more detail below by means of the appended drawings, in which:

FIG. 1 is a longitudinal sectional illustration of a high-pressure fuel pump with a pressure pulsation damper in a first embodiment, wherein the pressure pulsation damper has a damper capsule;

FIG. 2 is a longitudinal sectional illustration through a pressure pulsation damper as per a second embodiment on a high-pressure fuel pump from FIG. 1;

FIG. 3 shows a sectional view of a damper capsule in a first embodiment;

FIG. 4 shows a sectional view of a damper capsule in a second embodiment;

FIG. 5 shows a sectional view of a damper capsule in a third embodiment; and

FIG. 6 shows a sectional view of a damper capsule in a fourth embodiment.

### DETAILED DESCRIPTION

In some embodiments, a damper capsule for a pressure pulsation damper of a high-pressure fuel pump in a fuel injection system has a damping volume which is formed by at least one diaphragm, wherein the diaphragm has a deformation region which is deformable along a deformation axis by pressure pulsations and which serves for forming the damping volume and which has a connecting region for connecting the diaphragm to a closure element which closes off the damping volume. The diaphragm has a profile region which forms a spacer for spacing the deformation region apart, in the direction of the deformation axis, from holding elements which hold the damper capsule when the damper capsule is in an installed state. The deformation region, the connecting region and the profile region are formed as a unipartite diaphragm component.

By contrast to the known arrangements, in which the damper capsule is formed separately from the spacers, it is now proposed that, instead, the damper capsule be combined with the function of the spacer sleeve by virtue of the diaphragm having a profile region which is designed such that it itself can form the spacer. This gives rise to considerably reduced assembly effort, because only the damper capsule itself has to be installed into the pressure pulsation damper, rather than a damper capsule and additional spacers, as was previously the case. Altogether, the handling of the parts is also greatly simplified, which leads overall to a considerable cost saving. Furthermore, component costs can also be reduced through the integration of the function of the spacer sleeves into the damper capsule itself, specifically into the diaphragm.

The profile region may comprise a spring element, wherein the profile region is formed so as to be resilient in particular in a direction parallel to the deformation axis. The spacer sleeves that have hitherto been used have two tasks, specifically firstly imparting a prestress force to the damper capsule and secondly centering the damper capsule in a pressure pulsation damper of a high-pressure fuel pump. To perform these two functions, the spacer sleeves are often formed so as to be slightly resilient. In some embodiments, the profile region, which now performs all of the functions of the original spacer sleeve, may comprise a spring element.

In some embodiments, the profile region has passage openings through which fuel can flow during operation. The passage openings may be arranged such that the fuel can flow through the profile region in a radial direction.

In some embodiments, the deformation region, the connecting region, and/or the profile region may be arranged and/or formed rotationally symmetrically about a central axis, running parallel to the deformation axis, of the damper capsule. The deformation axis defines merely the direction in which the diaphragm deforms the damper capsule. Here, the deformation of the diaphragm is normally of lesser extent at the edges of said diaphragm than centrally, where the central axis runs. In this region, where the maximum deformation of the diaphragm is to be expected, the deformation axis and the central axis substantially coincide. A rotationally symmetrical form of the diaphragm about the central axis advantageously facilitates the centering of the diaphragm within the pressure pulsation damper.

In some embodiments, the profile region may comprise a profile ring arranged rotationally symmetrically about the central axis and formed in particular from profile ring parts spaced apart by interruption openings. A profile ring may be produced particularly easily; the same applies to profile ring parts that together form the profile ring. Said profile ring parts may be spaced apart from one another by interruption openings, that is to say the region that performs the function of a spacer, specifically the profile region, is not of closed encircling form over 360°, but rather has interruption openings in order to reduce the stiffness of the profile ring and thus increase the spring action. Furthermore, the fuel can thus flow better through this region.

In some embodiments, the profile region comprises a U-shaped profile in cross section. Here, a first U limb forms the connecting region and a second U limb forms a support region for the support of the damper capsule on the holding elements.

In some embodiments, the profile region, which in principle performs the functions of the original spacer sleeve, is formed such that good centering of an optional second damper capsule can be provided by means of said profile region. For this purpose, it the profile region, which is formed as a U-shaped profile, may engage around the closure element which is connected to the diaphragm in order to form the damping volume. It is thus possible, adjacent to the closure element, for a further damper capsule to be centered by means of the profile region, in particular by means of the support region of the U-shaped profile.

In some embodiments, the U-shaped profile may comprise a rounded form, wherein the passage openings through which fuel can flow during operation are situated on a U web that is arranged between the first U limb and the second U limb. U-shaped profiles, in particular rounded U-shaped profiles, are particularly easy to produce and are therefore suited to forming the profile region on the diaphragm.

In some embodiments, the profile region may comprise an S-shaped profile in cross section, with a contact loop for imparting a prestress to a connecting seam between the diaphragm and the closure element in the connecting region. This means that the profile region that performs the spacer function of the original spacer sleeve is formed such that, after the assembly process, the region of the connection between diaphragm and closure element is subject to a prestress, such that the connection is relieved of load.

In some embodiments, the diaphragm and the closure element are connected to one another in gas-tight fashion, in particular by adhesive bonding or welding, to form the damping volume, wherein, in particular, a gas is arranged in the damping volume. Therefore, the diaphragm and the closure element may be sealed by welding at a defined pressure with a filling, specifically the gas arranged in the damping volume. However, other alternatives are also conceivable in which the diaphragm and the closure element are connected to one another in gas-tight fashion in some other manner, for example by adhesive bonding. A defined pressure in the damping volume permits defined damping of pressure pulsations when the damper capsule is installed in the pressure pulsation damper.

In some embodiments, the closure element may comprise a closure diaphragm which has a deformation region of mirror-symmetrical form with respect to the diaphragm and a connecting region of mirror-symmetrical form with respect to the diaphragm. In such embodiments, the closure diaphragm and the diaphragm are placed one on top of the other in their connecting regions and are connected to one another in gas-tight fashion there.

In some embodiments, the closure diaphragm has a mirror-symmetrical form with respect to the diaphragm. Here, it is then the case that both the diaphragm and the closure diaphragm each have the profile region that forms the spacer. Thus, both the diaphragm and the closure diaphragm, which together form the damper capsule, each have the function of the original spacer sleeve integrated therein, that is to say a damper capsule formed in this way can then, in relation to the original arrangement, advantageously replace a damper capsule and two spacer sleeves.

In some embodiments, the damper capsule, in a pressure pulsation damper, may either be arranged in a housing that forms the damper housing of the pressure pulsation damper or placed on a housing of the high-pressure fuel pump and then merely closed off by means of a damper cover, wherein, in this case, the housing of the high-pressure fuel pump forms the pressure pulsation damper together with the damper cover.

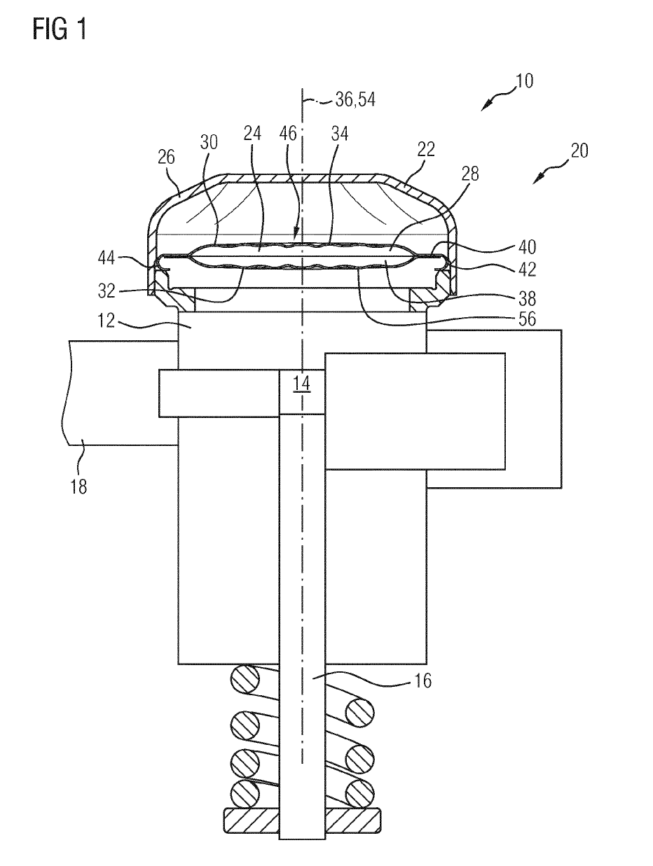

FIG. 1 is a drawing showing a longitudinal sectional illustration of a high-pressure fuel pump 10, which has, in a housing 12, a pressure chamber 14 in which a fuel is periodically compressed and relieved of pressure by a translational movement of a pump piston 16. After compression, the highly pressurized fuel is discharged from the pressure chamber 14 via a high-pressure outlet 18. The fuel is fed to the pressure chamber 14 from a low-pressure region 20 of the high-pressure fuel pump 10. In the low-pressure region 20, there is arranged a pressure pulsation damper 22 which, during the operation of the high-pressure fuel pump 10, dampens pressure pulsations that occur inter alia as a result of the movement of the pump piston 16 in the pressure chamber 14. For this purpose, the low-pressure damper 22 has a damper capsule 24.

In some embodiments, said pressure pulsation damper is formed by a damper cover 26, which interacts with the housing 12 of the high-pressure fuel pump 10 in order to thereby form the pressure pulsation damper 22. The damper capsule 24 has a damping volume 28 which is formed by a gas-tight connection of a diaphragm 30 and of a closure element 32.

In some embodiments, the diaphragm 30 has a deformation region 34 which, when pressure pulsations arise in the pressure pulsation damper 22, can deform along a deformation axis 36 to compress the damping volume 28, in which a gas 38 is arranged, and thus create space for the fuel that triggers the pressure pulsations. Formed in one piece with the deformation region 34, the diaphragm 30 has a connecting region 40 in which the closure element 32 and the diaphragm 30 are connected to one another in gas-tight fashion, for example by welding or adhesive bonding.

In some embodiments, the closure element 32 is of substantially mirror-symmetrical form with respect to the diaphragm 30, at least insofar as it likewise has the deformation region 34 and the connecting region 40. However, by contrast to the closure element 32, the diaphragm 30 additionally has a profile region 42 which engages around the connecting region 40 of the closure element 32 and forms a spacer 44 for spacing the deformation region 34 of the diaphragm 30 apart, in the direction of the deformation axis 36, from the housing 12 on which the profile region 42 lies. The profile region 42 is also formed in one piece with the connecting region 40 and with the deformation region 34, in order to thus, overall, form the diaphragm 30 as a unipartite diaphragm component 46. The damper capsule 24 will be discussed in more detail further below with reference to FIG. 3 to FIG. 6.

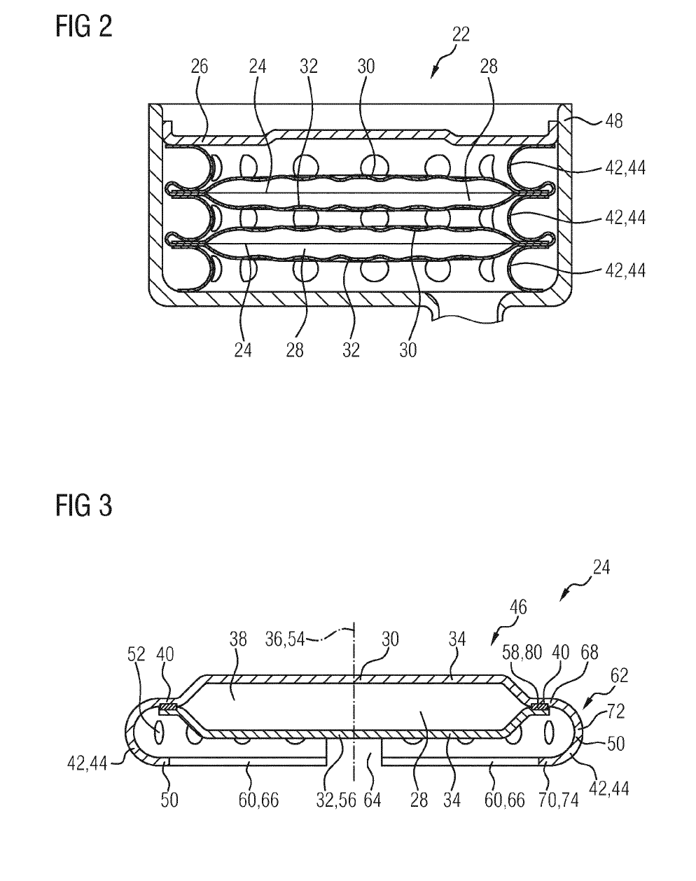

FIG. 2 is a drawing showing a longitudinal sectional illustration of a second embodiment of a pressure pulsation damper 22, which in this case has a dedicated damper housing 48, such that the housing 12 of the high-pressure fuel pump 10 no longer forms a partial region of the pressure pulsation damper 22. Rather, in the second embodiment, the pressure pulsation damper 22 is preassembled and then fastened in the fully assembled state to the housing 12 of the high-pressure fuel pump. The pressure pulsation damper 22 in FIG. 2 also has two damper capsules 24 rather than only one.

FIG. 3 to FIG. 6 show sectional illustrations of the damper capsule 24 in different embodiments. All of the embodiments are applicable to the two embodiments of the pressure pulsation dampers 22 in FIG. 1 and FIG. 2. In all of the embodiments of the damper capsule 24 described below, the profile region 42 is formed as a spring element 50 and, here, is resilient in the direction of the deformation axis 36. Furthermore, in all of the embodiments described below, the profile region 42 has passage openings 52 through which fuel can flow during operation. Said passage openings 52 are optional features, which do not imperatively have to be provided.

In some embodiments, such as in all of the embodiments in FIG. 3 to FIG. 6, the deformation region 34, the connecting region 40, and the profile region 42 are arranged rotationally symmetrically about a central axis 54 that runs parallel to the deformation axis 36 and centrally through the damper capsule 24. Here, the connecting region 40 and the deformation region 34 are in particular not only arranged rotationally symmetrically about the central axis 54 but also of rotationally symmetrical form, and thus of encircling form through 360°.

FIG. 3 is a sectional illustration of a first embodiment of the damper capsule 24, in the case of which the closure element 32 is formed as a closure diaphragm 56 and has the deformation region 34 and the connecting region 40 mirror-symmetrically with respect to the diaphragm 30. The closure diaphragm 56 and the diaphragm 30 are in this case connected to one another by means of a gas-tight weld seam 58 in the connecting region 40. The closure diaphragm 56 however does not have the profile region 42.

The profile region 42 is formed in FIG. 3 as a profile ring 60, wherein the profile ring 60 is formed as a U-shaped profile 62 in cross section. The profile ring 60 is not of fully encircling form through 360° about the central axis 54, with interruption openings 64 rather being provided, which divide the profile ring 60 into profile ring parts 66. Said interruption openings 64 serve for reducing the stiffness of the profile ring 60 and thus increasing the spring action of the profile region 42. Depending on requirements, said interruption openings may however also be omitted, such that the profile ring 60 is of fully encircling form through 360° about the central axis 54.

The profile ring 60 formed as a U-shaped profile 62 has a first U limb 68 and a second U limb 70, which are connected to one another by a U web 72. Here, the U-shaped profile 62 is of rounded form, such that the first U limb 68, the U web 72 and the second U limb 70 transition into one another without a step.

Here, the first U limb 68 forms the connecting region 40 of the diaphragm 30, whereas the second U limb 70 forms a support region with which the profile region 42 can be supported on, for example, the housing 12 of the high-pressure fuel pump 10. The U-shaped profile 62 is arranged so as to engage around the closure diaphragm 56.

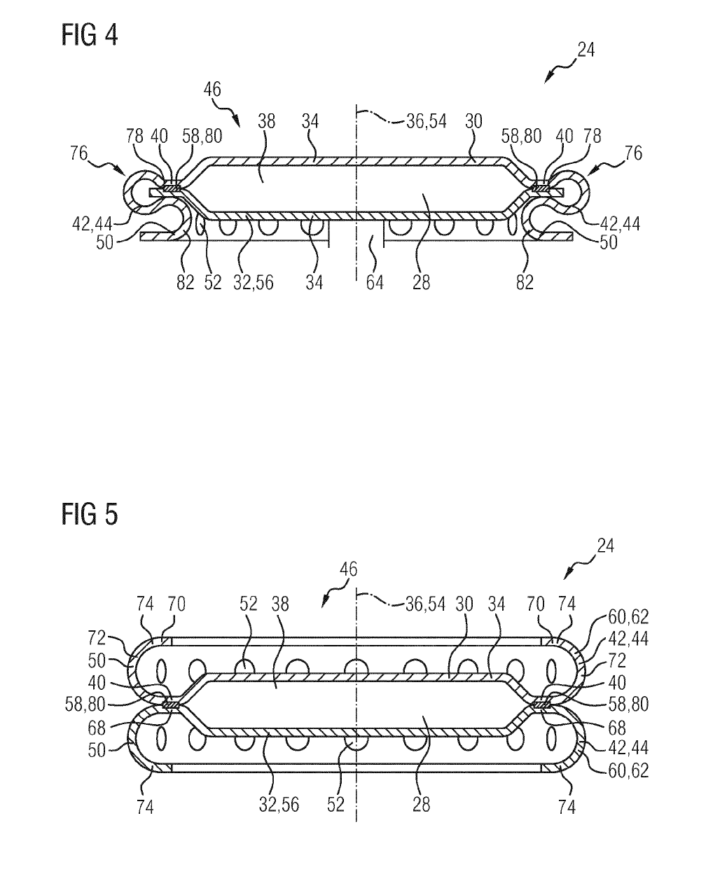

FIG. 4 shows a sectional view of a second embodiment of the damper capsule 24, wherein the closure diaphragm 56 is designed as in the embodiment as shown in FIG. 3, but the diaphragm 30 has a different shape. This is because, here, the profile region 42 is formed not as a simple U-shaped profile 62 but as an S-shaped profile 76, which likewise engages around the closure diaphragm 56 in the connecting region 40. Here, the S-shaped profile 76 has a contact loop 78 which presses against the connecting region 40 of the closure diaphragm 56 and thus imparts a prestress to a connecting seam 80, formed by the weld seam 58, between closure diaphragm 56 and diaphragm 30. Accordingly, in FIG. 4, the profile region 42 is formed such that, after the assembly process, the weld seam 58 is subjected to a prestress, such that the weld seam 58 is relieved of load. The S-shaped profile 76 has, in addition to the contact loop 78, a further S loop 82 which, like the second U limb 70 in the first embodiment in FIG. 3, acts as a support region 74. Said S loop 82 may optionally also be utilized for centering a further damper capsule 24.

FIG. 5 shows a sectional view of a third embodiment of the damper capsule 24, wherein the closure diaphragm 56 is of entirely mirror-symmetrical form with respect to the diaphragm 30. The profile region 42 is in this case again formed as a U-shaped profile 62 in cross section, but the U-shaped profile 62 does not engage around the closure diaphragm 56 or the diaphragm 30 but is formed so as to be bent away from the connecting region 40.

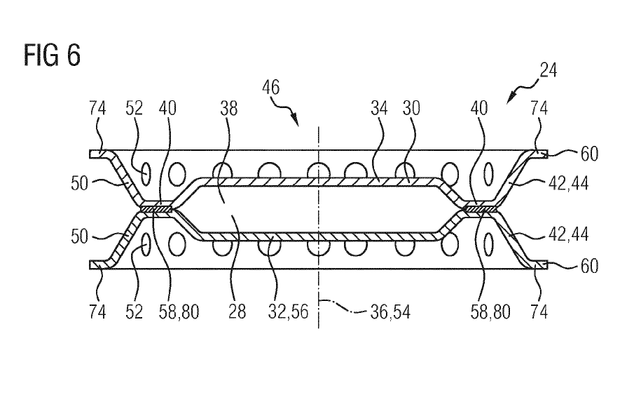

FIG. 6 shows a sectional view of a fourth embodiment of the damper capsule 24, wherein, again, the closure diaphragm 56 and diaphragm 30 are of entirely mirror-symmetrical form with respect to one another. Here, the profile region 42 is formed merely so as to be bent away from the connecting region 40 in order to thereby form a spacer region.

In the embodiments as per FIG. 5 and FIG. 6, both the closure diaphragm 56 and the diaphragm 30 each have the profile region 42 as an integrated spacer 44, that is to say said components then replace both a damper capsule 24 and two spacer sleeves of a conventional arrangement.

What is claimed is:

1. A damper capsule for a pressure pulsation damper of a high-pressure fuel pump in a fuel injection system, the damper capsule comprising:
a damping volume including a diaphragm having a deformation region deformable along a deformation axis by pressure pulsations and a connecting region; and
a closure element for closing off the damping volume and connected to the diaphragm by a closure element;
wherein the diaphragm includes a profile region forming a spacer for separating the deformation region, in the direction of the deformation axis, from holding elements which hold the damper capsule when the damper capsule has been installed;
wherein the deformation region, the connecting region, and the profile region comprise a unipartite diaphragm component.

2. The damper capsule as claimed in claim 1, wherein the profile region comprises a spring element resilient in a direction parallel to the deformation axis.

3. The damper capsule as claimed in claim 1, wherein the profile region includes passage openings through which fuel can flow during operation.

4. The damper capsule as claimed in claim 1, wherein the deformation region, the connecting region, and the profile region are rotationally symmetric about a central axis running parallel to the deformation axis of the damper capsule.

5. The damper capsule as claimed in claim 4, wherein the profile region comprises a profile ring rotationally symmetric about the central axis and including multiple profile ring parts spaced apart by interruption openings.

6. The damper capsule as claimed in claim 1, wherein the profile region comprises a U-shaped profile in cross section, a first U limb forms the connecting region, and a second U limb forms a support region for the damper capsule on the holding elements.

7. The damper capsule as claimed in claim 1, wherein the profile region comprises an S-shaped profile in cross section, having a contact loop imparting a prestress to a connecting seam between the diaphragm and the closure element in the connecting region.

8. The damper capsule as claimed in claim 1, wherein:
the diaphragm and the closure element are connected to one another in gas-tight fashion to form the damping volume; and
a gas is arranged in the damping volume.

9. The damper capsule as claimed in claim 1, wherein the closure element comprises:
a closure diaphragm with a mirror-symmetrical deformation region with respect to the diaphragm; and
a connecting region of mirror-symmetrical form with respect to the diaphragm.

10. A pressure pulsation damper for a high-pressure fuel pump, the pressure pulsation damper comprising:
a damping volume including a diaphragm having a deformation region deformable along a deformation axis by pressure pulsations and a connecting region; and
a closure element for closing off the damping volume and connected to the diaphragm by a closure element;
wherein the diaphragm includes a profile region forming a spacer for separating the deformation region, in the direction of the deformation axis, from holding elements which hold the damper capsule when the damper capsule has been installed;
wherein the deformation region, the connecting region, and the profile region comprise a unipartite diaphragm component.

11. A high-pressure fuel pump for a fuel in a fuel injection system, the high-pressure fuel pump comprising:
a compression chamber;
a high-pressure region downstream of the compression chamber; and
a low-pressure region with a damper capsule comprising:
a damping volume including a diaphragm having a deformation region deformable along a deformation axis by pressure pulsations and a connecting region; and
a closure element for closing off the damping volume and connected to the diaphragm by a closure element;
wherein the diaphragm includes a profile region forming a spacer for separating the deformation region, in the direction of the deformation axis, from holding elements which hold the damper capsule when the damper capsule has been installed;
wherein the deformation region, the connecting region, and the profile region comprise a unipartite diaphragm component,
a pressure pulsation damper as claimed in claim 10.
